(19) United States
(12) Patent Application Publication
(10) Pub. No.: US 2014/0262048 A1
(43) Pub. Date: Sep. 18, 2014

(54) CONVEYING DEVICE

(71) Applicant: TOYO TIRE & RUBBER CO., LTD., Osaka (JP)

(72) Inventors: Ryoshi Miyamoto, Osaka-shi (JP); Sousuke Tsubotani, Osaka-shi (JP)

(73) Assignee: TOYO TIRE & RUBBER CO., LTD., Osaka (JP)

(21) Appl. No.: 14/184,812

(22) Filed: Feb. 20, 2014

(30) Foreign Application Priority Data
Mar. 18, 2013 (JP) 2013-055318

(51) Int. Cl. B29D 30/48

(52) U.S. Cl. CPC B29D 30/48
USPC 156/422

(57) ABSTRACT

A conveying device which receives a curved rubber member supplied from a supply device and delivers the rubber member to a supply target device, the conveying device including a rotary table having an annular mounting surface on which the curved rubber member is placed, and a moving mechanism capable of moving the rotary table between a receiving position and a delivery position, wherein the rotary table is rotated at the receiving position to roll up the rubber member, is moved from the receiving position to the delivery position, and is reversely rotated at the delivery position to roll back the rubber member.

### BACKGROUND OF THE INVENTION

1. Field of the Invention

The present invention relates to a conveying device that receives a curved rubber member supplied from a supply device and delivers the rubber member to a supply target device.

2. Description of the Related Art

In the manufacture of pneumatic tires, the following method is frequently used when an annular bead filler is molded. That is, a bead filler having a predetermined cross-sectional shape is straightly extruded, the bead filler is wound around an outer peripheral side of a bead wire, and ends thereof are bonded to each other. However, when the bead filler is wound around the bead wire, a tensile force is generated due to a difference between an inner periphery and an outer periphery of the bead filler, and the tensile force causes problems that the outer periphery of the bead filler is bent or thinned, the bonded portion is peeled off, and cut rubber is generated.

In order to solve these problems, in JP 2002-527269 A, a straightly extruded bead filler is spirally wound around a drum such that an inner diameter of the bead filler becomes smaller than an outer diameter of the bead wire and thereafter, the spiral bead filler is detached from the drum to loosen its spiral state, thereby making the tensile force moderate. In JP 8-118515 A, a straightly extruded bead filler is spirally wound, and the wound bead filler is cooled by cooling water, thereby moderating internal stress.

In JP 2002-527269 A, the straightly extruded bead filler is caused to pass through a forming member having an opening corresponding to a cross-sectional shape of the bead filler, so that the bead filler is spirally formed while maintaining the cross-sectional shape. Hence, in the case of viscous rubber, a surface of the bead filler which is in contact with the forming member is likely to be varied in shape. Particularly, in the case of a bead filler which has thin cross-sectional shape and large height, it is extremely difficult to form the bead filler while maintaining a desired cross-sectional shape. Moreover, in JP 8-118515 A, since the bead filler is wound between two drums arranged side by side and is cooled in this state, the bead filler is extended between the two drums.

Hence, when an annular bead filler is molded, instead of employing a method in which a bead filler straightly extruded from the extrusion device is curved annularly, it is preferable to employ a method in which a bead filler is extruded from an extrusion device in a state where the bead filler is curved to a desired curvature, and the bead filler is molded annularly while maintaining the curvature. However, it is difficult to convey the curved extruded bead filler to a molding machine while maintaining its curvature.

### SUMMARY OF THE INVENTION

It is therefore an object of the present invention to provide a conveying device capable of conveying a curved rubber member supplied from a supply device to a supply target device while maintaining its curvature.

The above object can be achieved by the following invention.

Specifically, the present invention provides a conveying device which receives a curved rubber member supplied from a supply device and delivers the rubber member to a supply target device, the conveying device comprising:

a rotary table having an annular mounting surface on which the curved rubber member is placed; and

a moving mechanism capable of moving the rotary table between a receiving position and a delivery position, wherein

the rotary table is rotated at the receiving position to roll up the rubber member, is moved from the receiving position to the delivery position, and is reversely rotated at the delivery position to roll back the rubber member.

The conveying device of the present invention receives a curved rubber member supplied from the supply device and delivers the rubber member to the supply target device. Since the conveying device includes the rotary table for rolling up the curved rubber member supplied from the supply device on the annular mounting surface, the conveying device can receive the curved rubber member while maintaining its curvature. The conveying device also includes the moving mechanism capable of moving the rotary table between the receiving position and the delivering position, and the conveying device can convey the rubber member received from the supply device to the supply target device. Since the rotary table can rotate at the delivering position to roll back the rubber member on the mounting surface, it is possible to deliver the curved rubber member while maintaining its curvature. As a result, according to the conveying device of the present invention, the curved rubber member supplied from the supply device can be conveyed to the supply target device while maintaining its curvature.

In the conveying device according to the present invention, it is preferable that, at the receiving position, the mounting surface is flush with a conveying surface of the supply device which conveys the rubber member while supporting a lower surface of the rubber member.

According to this configuration, when the rubber member is received from the supply device at the receiving position, there is no difference in level between the conveying surface of the supply device and the mounting surface of the rotary table. Thus, it is possible to appropriately maintain the curvature of the rubber member.

In the conveying device according to the present invention, it is preferable that the rotary table has a circular truncated cone shape, and the mounting surface is a side surface of the circular truncated cone.

If the rotary table has the circular truncated cone shape, it is easy to dispose the rotary table at the receiving position and the delivering position, and it is also easy to place the rubber member on the mounting surface.

In the conveying device according to the present invention, it is preferable that the moving mechanism includes an oscillating mechanism capable of oscillating the rotary table in a vertical direction, and a rotating mechanism capable of rotating the oscillating mechanism in a horizontal plane.

According to this configuration, it is possible to accurately move the rotary table to the receiving position and the delivering position.

It is preferable that the conveying device according to the present invention includes a grasping mechanism which grasps a rolled-up end with the end kept away from the mounting surface when the rubber member is rolled up by the rotary table.

According to this configuration, if the grasping mechanism delivers the grasped rolled-up end to the supply target device, it is possible to smoothly deliver the rubber member. Thus, it is possible to appropriately maintain a curvature of the rubber member.

### BRIEF DESCRIPTION OF THE DRAWINGS

FIG. 1 is a perspective view showing an entire conveying device of the present invention;

FIG. 2 is a diagram showing a state where the conveying device receives a rubber member from a supply device;

FIG. 3 is a diagram showing a state where the conveying device delivers the rubber member to a supply target device;

FIG. 4 is a diagram schematically showing a positional relation between a rotary table and a roller conveyor at a receiving position;

FIG. 5 is a plan view when the rotary table is at a delivery position;

FIG. 6 is a perspective view showing a grasping mechanism; and

FIG. 7 is a perspective view showing a conveying device according to another embodiment.

### DETAILED DESCRIPTION OF THE PREFERRED EMBODIMENTS

An embodiment of the present invention will be described below with reference to the drawings. FIG. 1 is a perspective view showing an entire conveying device. A conveying device 1 of the present invention receives a curved rubber member supplied from a supply device, and delivers the rubber member to a supply target device.

Although a shape of the rubber member is not particularly limited, the conveying device of the present invention is useful in conveying the rubber member which has a thin and wide cross-sectional shape and is curved in a width direction. The present embodiment shows the rubber member extruded from an extrusion device in a curved state, to mold an annular bead filler which is longitudinally long and has a substantially triangular cross section.

The conveying device 1 includes a rotary table 11 having an annular mounting surface on which the curved rubber member can be placed, and a moving mechanism 12 capable of moving the rotary table 11 between a receiving position and a delivery position. In the present invention, a position of the rotary table 11 when the rubber member is received from the supply device is referred to as the receiving position, and a position of the rotary table 11 when the rubber member is delivered to the supply target device is referred to as the delivery position. FIG. 2 shows a state where the rotary table 11 is positioned at the receiving position, and FIG. 3 shows a state where the rotary table 11 is positioned at the delivery position.

The rotary table 11 of the present embodiment has a circular truncated cone shape. The rotary table 11 has a disk-like upper surface 11a and a bottom surface 11b, as well as an annular side surface 11c. A rotation shaft 111 is concentrically connected to the bottom surface 11b. The rotary table 11 can rotate around the rotation shaft 111 in a normal direction and an opposite direction at an arbitrary speed. A side surface 11c functions as the mounting surface on which the curved rubber member can be placed while maintaining its curvature.

The moving mechanism 12 includes an oscillating mechanism 121 capable of oscillating the rotary table 11 in the vertical direction, and a rotating mechanism 122 capable of rotating the oscillating mechanism 121 in a horizontal plane.

The rotation shaft 111 connected to the bottom surface 11b of the rotary table 11 is fixed to the oscillating mechanism 121. The oscillating mechanism 121 can oscillate the rotation shaft 111 around an oscillating axis extending in a horizontal direction. The rotating mechanism 122 supports the oscillating mechanism 121. The rotating mechanism 122 can rotate the oscillating mechanism 121 in the horizontal plane, and as a result, the rotating mechanism 122 can rotate the rotation shaft 111 in the horizontal plane. Motors (not shown) are used for the oscillating mechanism 121 and the rotating mechanism 122.

It is preferable that the moving mechanism 12 includes a horizontal moving mechanism capable of moving the rotating mechanism 122 in the horizontal direction, and a vertical moving mechanism capable of moving the rotating mechanism 122 in the vertical direction. Accordingly, the rotary table 11 can be moved in the vertical direction and the horizontal direction, and is adaptable to various types of supply devices and supply target devices.

As shown in FIG. 2, the rotary table 11 rotates at a roll-up position to roll up and receive a rubber member 2 supplied from the supply device on a side surface 11c (corresponding to the mounting surface). In this manner, the conveying device 1 can receive the curved rubber member 2 from the supply device while maintaining its curvature.

The present embodiment shows a roller conveyor 3 as one example of the supply device. The roller conveyor 3 is configured by a plurality of rollers which rotate while supporting a lower surface of the curved rubber member 2.

The roller conveyor 3 includes a support 31 and a plurality of rollers 32. The rollers 32 are spirally arranged around the support 31 to constitute a spiral conveying surface 3a. The rollers 32 rotate and convey the rubber member 2 while supporting the lower surface of the rubber member 2. Here, the conveying surface 3a spirally extends downward from above to surround peripheries of the support 31, and can spirally convey the rubber member 2 downwardly from above. The plurality of rollers 32 are sequentially arranged downwardly from above at positions gradually shifted in a circumferential direction, and arranged roller surfaces 32a constitute the spiral conveying surface 3a. FIGS. 2 and 3 show only a part of the plurality of rollers 32.

FIG. 4 is a diagram corresponding to FIG. 2 as viewed from the left side. FIG. 4 schematically shows a positional relation between the side surface 11c of the rotary table 11 and the rollers 32 of the roller conveyor 3 at the receiving position. It is preferable that the side surface 11c is flush with the conveying surface 3a of the roller conveyor 3 when the rotary table 11 is at the receiving position. The rotary table 11 of the present embodiment has a circular truncated cone shape, and the side surface 11c is a curved surface. Hence, the side surface 11c and the conveying surface 3a being flush with each other means that the conveying surface 3a and a plane in contact with the side surface 11c are substantially flush with each other. When the side surface 11c and the conveying surface 3a are flush with each other, there is no difference in level between the conveying surface 3a of the roller conveyor 3 and the side surface 11c of the rotary table 11 when the rubber member 2 is received from the roller conveyor 3 at the receiving position. Thus, it is possible to appropriately maintain the curvature of the rubber member 2.

The conveying device 1 conveys the rubber member 2 received from the roller conveyor 3 to the supply target device. The conveying device 1 moves the rotary table 11 from the receiving position shown in FIG. 2 to the delivery position in FIG. 3 by the oscillating mechanism 121 and the rotating mechanism 122. At this time, a horizontally moving mechanism and a vertically moving mechanism are also used as necessary.

As shown in FIG. 3, the rotary table 11 can reversely rotate at the delivery position to roll back the rubber member 2 on the side surface 11c, and deliver the rubber member 2 to the supply target device. In this manner, the conveying device 1 can deliver the curved rubber member 2 to the supply target device while maintaining its curvature.

In the present embodiment, a molding drum 4 is shown as one example of the supply target device. The molding drum 4 is rotated and driven around a drum axis extending in the horizontal direction, and can roll up the rubber member 2. In the present embodiment, a bead wire 21 is previously wound around the surface of the molding drum 4, and the rubber member 2 is rolled up around an outer peripheral side of the bead wire 21.

FIG. 5 is a plan view showing a state where the rotary table 11 is positioned at the delivery position. When the rotary table 11 is positioned at the delivery position, the side surface 11c is substantially perpendicular to a drum surface 4a of the molding drum 4.

As shown in FIG. 6, it is preferable that the conveying device 1 of the present invention includes a grasping mechanism 5 which grasps a rolled-up end 2a with the end 2a kept away from the side surface 11c when the rubber member 2 is rolled up by the rotary table 11. The grasping mechanism 5 includes a grasping portion 51. The grasping mechanism 5 can grasp the rolled-up end 2a immediately before the rubber member 2 is completely rolled up. In this manner, it is possible to prevent the rolled-up end 2a from being adhered to a roll-up start end 2b. The grasping mechanism 5 moves from the receiving position to the delivery position together with the rotary table 11, and the rolled-up end 2a grasped by the grasping portion 51 is attached to the molding drum 4, thereby smoothly delivering the rubber member 2. Thus, it is possible to appropriately maintain the curvature of the rubber member 2.

### Other Embodiments

(1) The rotary table 11 may have a disk shape as shown in FIG. 7. At this time, an outer peripheral side of the disk becomes the mounting surface. When the rotary table 11 has such a disk shape, it is preferable that the support 31 is hung from above so that the rotary table 11 does not interfere with the support 31 of the roller conveyor 3 at the receiving position.

(2) Although the roller conveyor 3 is shown as one example of the supply device in the embodiment described above, the present invention is not limited thereto. For example, an extrusion device which can extrude the rubber member 2 in a curved state can be used to directly supply the curved rubber member 2.

(3) The roller conveyor 3 which conveys the rubber member 2 downwardly from above is shown as one example of the supply device in the embodiment described above. Alternatively, the roller conveyor 3 may convey the rubber member 2 upwardly from below.

What is claimed is:

1. A conveying device which receives a curved rubber member supplied from a supply device and delivers the rubber member to a supply target device, the conveying device comprising:
a rotary table having an annular mounting surface on which the curved rubber member is placed; and
a moving mechanism capable of moving the rotary table between a receiving position and a delivery position, wherein
the rotary table is rotated at the receiving position to roll up the rubber member, is moved from the receiving position to the delivery position, and is reversely rotated at the delivery position to roll back the rubber member.

2. The conveying device according to claim 1, wherein
at the receiving position, the mounting surface is flush with a conveying surface of the supply device which conveys the rubber member while supporting a lower surface of the rubber member.

3. The conveying device according to claim 1, wherein
the rotary table has a circular truncated cone shape, and the mounting surface is a side surface of the circular truncated cone.

4. The conveying device according to claim 1, wherein
the moving mechanism includes an oscillating mechanism capable of oscillating the rotary table in a vertical direction, and a rotating mechanism capable of rotating the oscillating mechanism in a horizontal plane.

5. The conveying device according to claim 1, further comprising a grasping mechanism which grasps a rolled-up end with the end kept away from the mounting surface when the rubber member is rolled up by the rotary table.
